(19) United States
(12) Patent Application Publication
(10) Pub. No.: US 2018/0209699 A1
(43) Pub. Date: Jul. 26, 2018

(54) METHOD FOR PREPARING ADSORPTION DEVICE

(71) Applicant: Calsonic Kansei Corporation, Saitama-city, Saitama (JP)

(72) Inventors: Shinnosuke MAEDA, Saitama-city, Saitama (JP); Tomohiro MARUYAMA, Saitama-city, Saitama (JP)

(21) Appl. No.: 15/744,882

(22) PCT Filed: Aug. 25, 2016
(86) PCT No.: PCT/JP2016/074759

§ 371 Date: Jan. 15, 2018

(30) Foreign Application Priority Data
Aug. 31, 2015 (JP) 2015-170855

(51) Int. Cl. F25B 17/08; F25B 35/04; F25B 37/00; B29C 39/10; B29C 39/00

(52) U.S. Cl. CPC F25B 17/08; F25B 35/04; F25B 37/00; F28D 9/0062; B29C 39/003; F28F 2235/00; B29C 39/10

(57) ABSTRACT

Problem To suppress the distribution of adsorption materials and binders between a heat-transfer member and a heat-transfer member from being disproportioned.

SOLUTION TO PROBLEM There is provided a method for preparinq an adsorption device in which activated carbons are held in an area α of accommodating a plurality of heat-transfer members 34 arranged by intervals with each other in a main body part 31. The method includes a filling step (step 102) for filling a slurry filler 45, in which porous particles 41 and binder resins 42 are dispersed in a solvent 46, into the area α, to fill the filler 45 into at least a clearance S between the heat-transfer member 34 and the heat-transfer member 34, an evaporating step (step 103) for heating the main body part 31 in which the filler 45 is filled in the area α in a first-temperature range to evaporate the solvent 46, and a hardening step (step 104) for heating the main body part 31 in which the solvent 46 is evaporated in the evaporating step (step 103) in a second temperature range higher than the first temperature range to harden the binder resins 42.

### TECHNICAL FIELD

The present invention relates to a method for preparing an adsorption device.

### RELEVANT ART

Patent document 1 discloses a method for preparing an adsorption material module in which adsorption materials are filled between a plurality of heat-transfer plates (heat-transfer members) arranged by intervals with each other.

### PRIOR ART DOCUMENT

### Patent Document

Patent Document 1: Japanese Patent No. 3867348

In the preparing method according to this Patent Document 1, the adsorption material module is prepared via a steps of: filling adsorption materials which adsorb water to be saturated in a clearance between the heat-transfer member and the heat-transfer member; and filling a binder solution in which binders are diluted with water in a clearance between the heat-transfer member and the heat-transfer member.

### SUMMARY OF THE INVENTION

### Problem to Solution

In the adsorption material module, however, the clearance between adjacent the heat-transfer members is narrow, and the filled adsorption materials and the filled binders are difficult to mix uniformly. Therefore the finally acquired adsorption material module has a possibility that distribution of the adsorption materials and the binders is disproportioned.

Therefore, it is required to suppress the distribution of the adsorption materials and of the binders which are filled between adjacent the heat-transfer members and the heat-transfer member from being disproportioned.

The present invention is made in view of the aforementioned problems, and has an object of providing a method for preparing an adsorption device that can uniform a distribution of binders in a filler filled between a heat-transfer member and a heat-transfer member to suppress the distribution of the binders in adsorption materials after removing a solvent in an evaporating step from being disproportioned.

### Solution to Problem

The present invention relate to a method for preparing an adsorption device, in which a plurality of heat-transfer members are arranged with interval with each other and adsorption materials are held in an area in a main body part for accommodating the plurality of heat-transfer members,

the method includes a steps of:

a filling step for filling a slurry filler, in which the adsorption materials and binders are dispersed in a solvent, in the area;

an evaporating step for evaporating the solvent by heating the main body part in which the filler is filled in the area with a first temperature range adequate for the evaporation of the solvent; and

a hardening step for hardening the binders by heating the main body part, from which the solvent is evaporated in the evaporating step, with a second temperature range, the second temperature range is higher in temperature than the first temperature range and is adequate for the harden the binders.

### Advantageous Effect of the Invention

According to this method, the slurry filler in which the adsorption materials and the binders are dispersed in the solvent is filled between the heat-transfer member and the heat-transfer member. Thereby, to uniform the distribution of the binders in the filler filled between the heat-transfer member and the heat-transfer member is enabled. Also, after removing the solvent in the evaporating step, to suppress the distribution of the binders in the adsorption materials from being disproportioned is enabled.

### BRIEF DESCRIPTION OF THE DRAWINGS

FIG. 1 is a perspective view illustrating an adsorption device according to an embodiment of the present invention.

FIG. 2 is a flow chart explaining a method for preparing the adsorption device according to the embodiment.

FIG. 3 is drawings explaining a process of setting a main body part of an adsorption material module prior to holding adsorption materials to a form according to the embodiment.

FIG. 4 is a drawing explaining the filling of filler into an area surrounding heat-transfer members of the main body part in the inside of the form according to the embodiment.

FIG. 5 is schematic drawings explaining a process of preparing the adsorption materials from the filler according to the embodiment.

### DESCRIPTION OF EMBODIMENTS

[Configuration of Adsorption Device]

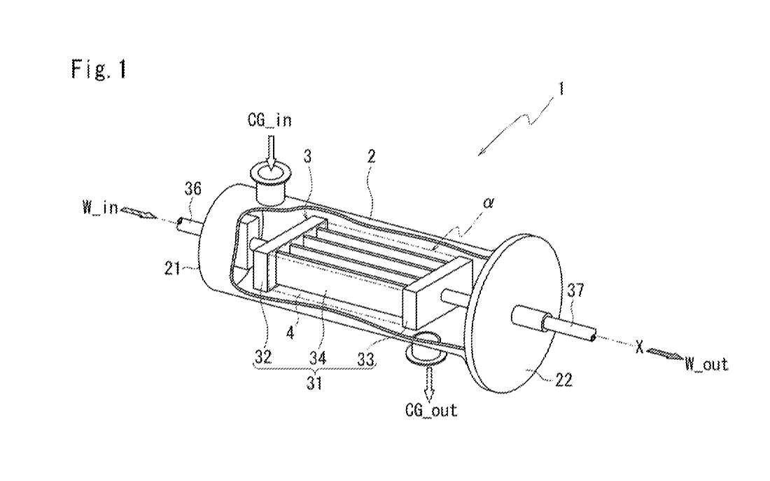

FIG. 1 is a perspective view illustrating an adsorption device 1 with a part of the adsorption device 1 being cut away.

As illustrated in FIG. 1, the adsorption device 1 includes an adsorption material module 3 and a tubular case 2.

A main body part 31 of the adsorption material module 3 holds adsorption materials 4 enabling adsorption/desorption of coolants (CG_in, CG_out).

The tubular case 2 accommodates an area (area α illustrated in a virtual line in the figure) where the adsorption materials 4 of the adsorption material module 3 are provided. The coolants CG passes through inside of the tubular case 2.

In this adsorption device 1, a low-temperature/high-temperature heat exchange medium (W_in, W_out) passes through the inside of the main body part 31. The adsorption and desorption of the coolant (CG) to the adsorption material 4 are designed to be performed by cooling/heating the adsorption material 4 through a low-temperature/high-temperature heat exchange medium (W_in, W_out).

In the adsorption material module 3, a branching tank 32 and a merging tank 33 are arranged in parallel with each other with intervals. A plurality of heat-transfer members 34, in which the heat exchange medium passes through, are provided between the branching tank 32 and the merging tank 33.

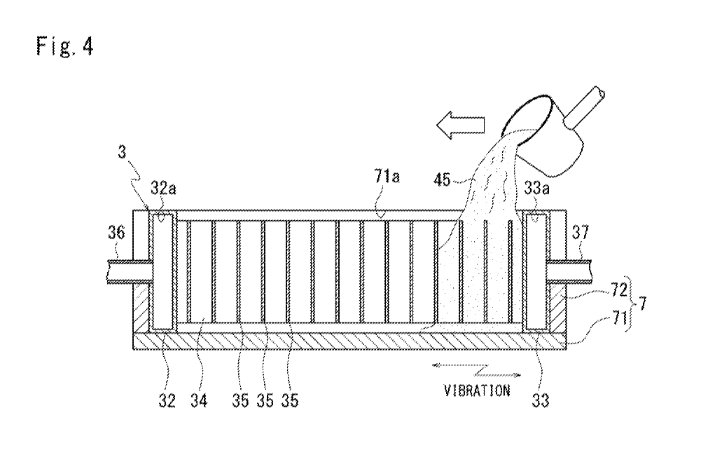

Each of the heat-transfer members 34 is provided in a direction perpendicular to the branching tank 32 and the merging tank 33. One end and the other end of the heat-transfer members 34 in a longitudinal direction are respectively communicated with internal spaces 32a, 33a (refer to FIG. 4) of the branching tank 32 and the merging tank 33.

A supply tube 36 and a discharge tube 37 of the heat exchange medium W are connected to the branching tank 32 and the merging tank 33 respectively.

The supply tube 36 and the discharge tube 37 are arranged coaxially on a center line X passing through the center of each of the branching tank 32 and the merging tank 33 in the longitudinal direction.

The supply tube 36 and the discharge tube 3 are respectively passes through one end part 21 and the other end part 22 of the tubular case 2.

In the adsorption device 1, the high-temperature/low-temperature heat exchange medium W supplied to the branching tank 32 through the supply tube 36. The heat exchange medium W is distributed in the branching tank 32 to flow in the inside of each of the heat-transfer members 34 and is then discharged to an exterior of the adsorption device 1 through the merging tank 33 and the discharge tube 37.

In the main body part 31, the adsorption materials 4 are held in the area α (area illustrated in a virtual line in the figure) surrounding the heat-transfer members 34. In the area α, the adsorption materials 4 enabling the adsorption/desorption of the coolants (CG) are held in a clearance as well between the heat-transfer member 34 and the heat-transfer member 34.

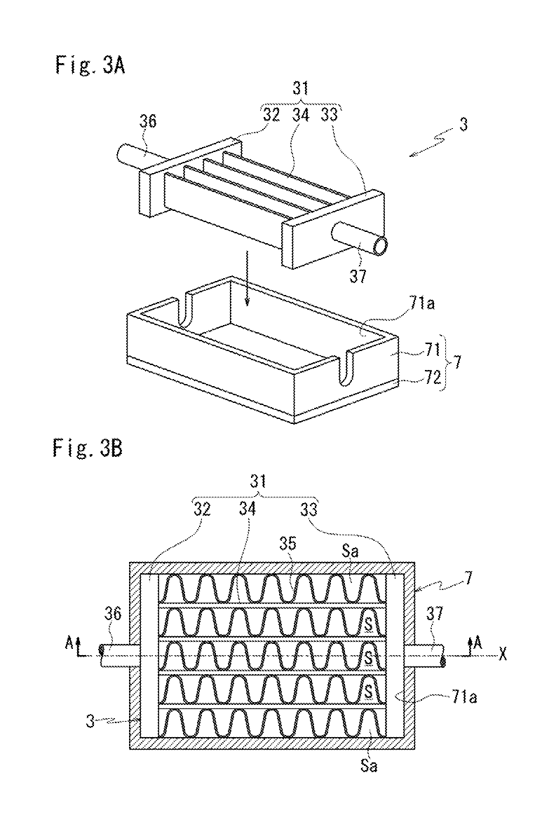

Here, a corrugate fin 35 is provided between the heat-transfer members 34 neighbored in the main body part 31 (refer to FIG. 3B). The corrugate fin 35 is fixed by soldering or the like in a state of being in contact with side surfaces of the neighbored heat-transfer members 34, 34 to face with each other. The adsorption materials 4 filled in the clearance between the heat-transfer member 34 and the heat-transfer member 34 are filled between the corrugate fin 35 and the heat-transfer member 34 as well without any clearance.

Therefore, when the adsorption materials 4 is cooled/heated by the high-temperature/low-temperature heat exchange medium W flowing in the inside of the main body part 31, it is possible to efficiently cool/heat almost all the adsorption materials 4 filled in the clearance between the heat-transfer members 34.

Thereby, cooling/heating of the adsorption materials 4 can be achieved with efficiency at the time of when performing the adsorption/desorption of the coolants (CG) to the adsorption materials 4.

[Absorption Material]

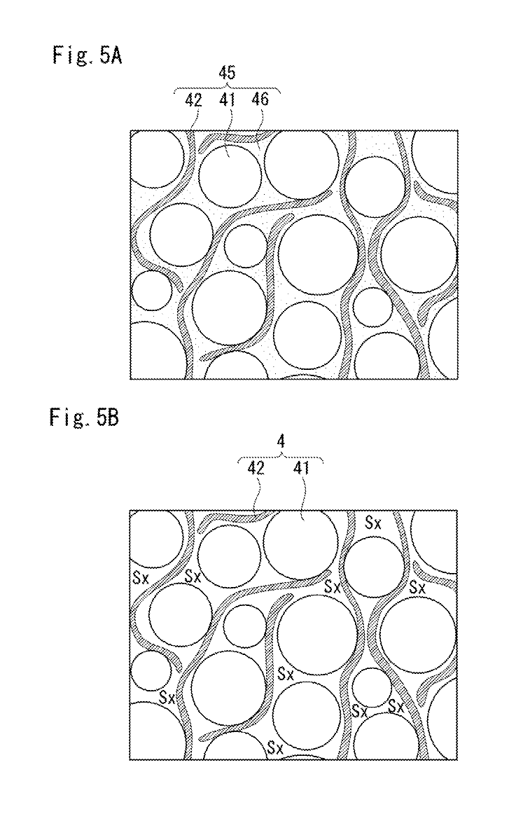

As illustrated in FIG. 5B, the adsorption material 4 is a mixing material of a porous particle 41 having many fine holes on a surface and a binder resin 42

The adsorption material 4 is a solid-state member prepared by using the slurry filler 45 in which the porous particles 41 and the binder resins 42 are dispersed in the solvent 46 (refer to FIG. 5A).

The adsorption mate rial 4 is manufactured by steps of: filling the slurry filler 45 in the area α surrounding the heat-transfer members 34, clearances S (see FIG. 3B) between the heat-transfer members 34 are included in the area a; removing the solvent 46 by the evaporating step as described later; and hardening the binder resin 42 by the hardening step as described later after.

[Porous Particle]

The porous particle 41 performs adsorption/desorption of coolants in response to temperatures. The binder resin 42 holds the shape of the adsorption material 4 filled in the area α surrounding the heat-transfer members 34. The binder resin 42 connects the adsorption material 4 and the heat-transfer member 34 to hold the adsorption material 4 within the area α surrounding the heat-transfer members 34.

The porous particle 41 is an adsorption material having a weak anionic property, and in the embodiment, an activated carbon is adopted as the porous particle 41.

Here, a particle diameter of the activated carbon (porous particle 41) contained in the adsorption material 4 is preferably equal to or less than 120 μm.

This is because as the particle diameter of the activated carbon becomes the larger, the bulk density of the activated carbons is the higher, and therefore a total amount of the activated carbons that can be filled in the area a surrounding the heat-transfer members 34 becomes small. Thereby, a total amount of the coolants that can be adsorbed in the activated carbons small.

In addition, as the particle diameter of the activated carbon becomes the larger, a surface area of the activated carbon becomes the larger. Therefore a total amount of the binder resins 42 adhered to the surfaces of the activated carbons increase. In this case, the surface adsorbing the coolant of the activated carbon is covered with the binder resin and to make an adsorption amount of the coolants small.

Further, when the surface of the activated carbon is covered with the binder resin 42, a total amount of the binder resins 42 contributing to keep the shape of the activated carbon filled in the area α surrounding the heat-transfer members 34 is made smaller. Thereby it is difficult to continue to hold the shape of the adsorption material 4 after hardening the binder resin 42 in a predetermined shape.

In this case, the adsorption material 4 may fall down from the area α surrounding the heat-transfer members 34 to make the total amount of the activated carbons involved in the adsorption/desorption in the adsorption device 1 smaller. Thus, it may be difficult to appropriately perform the adsorption/desorption of the coolant.

In addition, it is preferable that a lower limit of the particle diameter of the activated carbon is a minimum particle diameter in which the activated carbon can secure a clearance between the activated carbon and another neighbored activated carbon in the inside of the adsorption material 4.

Also, it is preferable that the lower limit of the particle diameter of the activated carbon is a minimum particle diameter in which the activated carbon can secure a clearance Sx (refer to FIG. 5B) which enables the pass through of a coolant (for example, ethanol).

This is for the following reason. When the activated carbon is arranged in a state of being densely stuck without any clearance to the other neighbored activated carbon in the inside of the adsorption material 4, the coolant cannot enter the inside of the adsorption material 4. In this case, the coolant is adsorbed only on a surface area of the adsorption material 4 to be difficult to be adsorbed in the internal area.

Then, since all of the activated carbons contained in the adsorption materials 4 cannot be involved in the adsorption of the coolant, the adsorption amount of the coolant in all the adsorption materials 4 is made small.

[Binder Resin]

The binder resin 42 is a water-soluble resin having a cationic property.

Since the aforementioned activated carbon has a weak anionic property, affinity between the activated carbon and the binder resin 42 increases by making the binder resin a cationic resin.

As a result, after the after-mentioned filler 45 is prepared by dispersing the activated carbons and the binder resins 42 in the solvent 46, separation between the activated carbon and the binder resin 42 is difficult to occur in the prepared filler 45.

Further, the activated carbon and the binder resin 42 are held in a state of being substantially equally mixed without being separated in the prepared filler 45. Therefore in finally acquired solid adsorption material 4, the binder resins 42 can be uniformly distributed, appropriately preventing the adsorption material 4 in the solid state from losing shape.

In the embodiment, it is preferable that an amount of the binder resins 42 is set such that a weight ratio of the binder resins 42 to the activated carbons is in a range of 1:0.05 to 1:0.15.

This is because when the weight ratio of the binder resins 42 to the activated carbons is less than 1:0.05, a relative amount of the binder resins 42 to the activated carbons is made small, making it impossible to bind the activated carbons without losing the shape.

In this case, the adsorption material 4 acquired by hardening the binder resin 42 loses the shape and falls down from the area α surrounding the heat-transfer members 34. As a result, an amount of the activated carbons that can be heated/cooled by the heat exchange medium W flowing in the main body part 31 is made small.

Therefore since the total amount of the activated carbons involved in the adsorption/desorption of the coolant in the adsorption device 1 is made small, it is difficult to appropriately perform the adsorption/desorption of the coolant.

In addition, when the weight ratio of the binder resins 42 to the activated carbons is more than 1:0.15, the relative amount of the binder resins 42 to the activated carbons is made large, making it possible to bind the activated carbons without losing the shape. But a ratio of covering the surface of the adsorption material 4 with the binder resin 42 increases. Then, the activated carbons involved in the adsorption of the coolant are made small in number, leading to lowering an adsorption rate of the coolant.

[Solvent]

The solvent 46 is a polarity solvent high in affinity with the activated carbon having the weak anionic property, and in the embodiment, ethanol is adopted as the solvent 46, but water or a mixing solvent of water and ethanol may be adopted.

In the filler 45 in which the activated carbons and the binder resins 42 are dispersed in the solvent 46 (ethanol), the slurry filler 45 is prepared by setting an amount of the ethanol such that a weight ratio of the ethanol to the activated carbons is in a range of 1:3 to 1:5.

When a weight ratio of the solvent 46 to the activated carbons is less than 1:3, since the prepared filler 45 is in a hard, solid state and does not become in a slurry state. The filler 45 cannot be filled without any clearance in the area α surrounding the heat-transfer members 34 containing the clearance between the heat-transfer members 34, 34.

When the weight ratio of the solvent 46 to the activated carbons is more than 1:5, viscosity of the adjusted filler 45 becomes too low. In this case, it is impossible to make the filler 45 remain in the area a surrounding the heat-transfer members 34 containing the clearance between the heat-transfer members 34, 34, even if the filler 45 is forced to be filled in the area α.

Further, when the viscosity of the filler 45 is too low, there are some cases where the activated carbon and the binder resin 42 are separated in the prepared filler 45 before filling the filler 45 in the area α surrounding the heat-transfer members 34. In this case, even if the filler 45 is filled in the area α, the activated carbon and the binder resin 42 are non-uniformly distributed in the finally acquired solid adsorption material 4. As a result, the activated carbons cannot be bound without losing the shape.

[Method for Preparing a Filler]

For preparing the adsorption device 1, the slurry filler 45 in which the activated carbons and the binder resins 42 are dispersed in the solvent 46 is in advance prepared.

Here, the method for preparing the filler 45 will be explained by taking a case where the porous particle 41 is the activated carbon, the solvent is ethanol, and the binder resin 42 is a water-soluble resin having a cationic property, as an example.

First, a mixture of the activated carbon and the ethanol is prepared by adding the ethanol to a predetermined amount of the activated carbons little by little for mixing (first mixing step). On this occasion, an amount of the activated carbons and the ethanol is set such that, the weight ratio of the ethanol to the activated carbons 1:3 to 1:5.

As a result, a pasty mixture in which the ethanol is adsorbed to the activated carbons can be acquired.

The filler 45 is prepared by adding the water solution of the binder resin 42, which is obtained by dispersing the cationic water-soluble resin to water and/or ethanol, to the mixture of the activated carbon and the ethanol little by little for mixing (second mixing step).

On this occasion, an amount of the cationic water-soluble binder resins 42 is set such that a weight ratio of the binder resins 42 to the activated carbons contained in the mixture is 1:0.05 to 1:0.15.

As a result, the slurry filler 45 in which the activated carbons and the binder resins 42 are mixed to be substantially uniformly distributed can be acquired.

Here, when the activated carbon and the ethanol are mixed, adsorption heat is generated due to adsorption of the ethanol to the activated carbon.

Therefore if a temperature of the mixture exceeds a softening temperature of the binder resin 42 when adding the water solution of the binder resins 42 to the mixture a temperature of which has increased by this adsorption heat, at least a part of the added binder resins 42 will be temporarily softened and will thereafter be hardened.

In this case, there are some cases where the slurry filler 45 in which the activated carbons and the binder resins 42 are mixed to be substantially uniformly distributed cannot be acquired.

Therefore there may be provided a step (cooling step) between the first mixing step and the second mixing step for cooling the mixture prepared in the first mixing step to less than the softening temperature of the binder resin 42.

[Method for Preparing an Adsorption Device]

Next, an explanation will be made of the method for preparing the adsorption device 1.

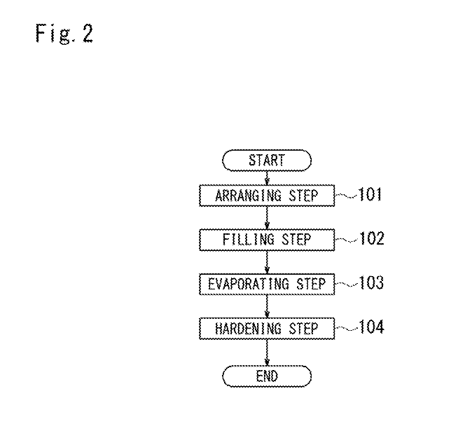

FIG. 2 is a flow chart, explaining the method for preparing the adsorption device 1.

FIG. 3 is drawings explaining setting of the main body part 31, to which the adsorption material 4 is not provided, of the adsorption material module 3 to the form 7. FIG. 3A is a perspective view illustrating a state immediately before setting the main body part 31 to the form 7. FIG. 3B is a plan view after setting the main body part 31 to the form 7. It should be noted that in FIG. 3A, for descriptive purposes, illustration of the corrugate fins 35 is omitted. Also, in FIG. 3B, a peripheral wail 71 of the form 7 is shown with hatching for enabling distinguishing between the form 7 and the adsorption material module 3 in visually.

FIG. 4 is a drawing explaining the filling of the filler 45 into the area a surrounding the heat-transfer members 34 of the main body part 31 in the inside of the form 7. This FIG. 4 corresponds to a cross section by cutting the periphery of the main body part 31 held by the form 7 along line A-A in FIG. 3B.

FIG. 5 is drawings explaining the process of preparing the adsorption material 4 from the filler 45. FIG. 5A is a schematic diagram by enlarging a part of the filler 45 filled in the area α surrounding the heat-transfer members 34 of the main body part 31. FIG. 5B is a schematic diagram illustrating the distribution of the activated carbons (porous particles 41) and the binder resins 42 in the adsorption material 4 prepared by evaporating the solvent 46 from the filler 45 in the evaporating step as described later.

As illustrated in FIGS. 3 A and 3B, firstly the main body part 31 is set to the bottomed form 7 an upper side of which opens (step 101 in FIG. 2: arranging step).

Here, the form 7 is formed in a bottomed and angular tubular shape. The form 7 includes the peripheral wall 71 surrounding the periphery of the main body part 31 over an entire circumference and a bottom wall 72 sealing a lower opening of the peripheral wall 71.

In the arranging step (step 101), the main body part 31 is inserted in the form 7 from an upper opening 71a of the form 7. Then, the supply tube 36, the discharge tube 37, the branching tank 32 and the merging tank 33 of the main body part 31 are fitted in the form 7 in a state of being supported by the peripheral wall 71 and the bottom wall 72.

In this state, the inside of the peripheral wall 71 in the form 7 is configured as an area (area α surrounding the heat-transfer members 34) for causing the heat-transfer members 34 to hold the adsorption material 4.

Then, as illustrated in FIG. 4, the aforementioned slurry filler 45 is made to inflow and be filled in the inside of the form 7, in which the main body part 31 has been set at arranging step of step 101 (step 102 in FIG. 2: filling step). Here, the filling of the slurry filler 45 is made by giving vibrations to the form 7 by an unillustrated vibration generating device.

Thereby, the filler 45 is filled in the area α surrounding the heat-transfer members 34 and the clearances S and Sa are filled with the filler 45. Here, the clearances S (see FIG. 3B) is between the heat-transfer member 34 and the heat-transfer member 34 neighbored to each other in the main body part 31. Also, the clearances Sa (see FIG. 3B) is between the heat-transfer member 34 and the peripheral wall 71.

Particularly since the slurry filler 45 is filled while vibrating the form 7, even if air is taken in the filled filler 45 to form gaps (air bubbles) due to high viscosity and low fluidity of the slurry filler 45, the formed air bubbles move to a surface side of the filler 45 by the vibration to be removed from the inside of the filler 45.

Accordingly the filler 45 is filled in narrow clearances as well surrounded by the corrugate fin 35 between the heat-transfer member 34 and the heat-transfer member 34 without taking air inside.

When the filling of the filler 45 in the inside of the heat-transfer members 34 is completed, the main body part 31 and the form 7 are together heated in a first temperature range (for example, 80° C. to 100° C.) for a predetermined time (step 103 in FIG. 2: evaporating step). Thereby, the ethanol and the water contained in the filler 45 is removed by the evaporation.

In this step 103, since the solvent 46 (ethanol) and the water components contained in the water solution of the binder resin 42 are evaporated, it is preferable that the first temperature range is a temperature range of being capable of evaporating both the solvent 46 and the water.

In the embodiment, the solvent 46 used for preparing the filler 45 is the ethanol, and the binder resin 42 is the binder resin water solution in which the cationic water-soluble resins are dispersed in the water. Therefore the aforementioned first temperature range is set to the temperature range of being capable of evaporating both the ethanol and the water.

Accordingly the first temperature range is set corresponding to the solvent and the binder resin.

In this evaporating step, the adsorption material 4 is formed by removing the solvent 46 and the water contained in the pasty filler 45.

Here, the fluidity of the pasty filler 45 is low, and even if clearances are formed in the inside of the filler 45 by the removal of the solvent 46 and the water, the circumferential filler 45 cannot be prevented from moving and quickly infilling the clearances. Therefore in the adsorption material 4 acquired by removing the solvent 46 and the water from the filler 45 in the evaporating step, areas where the solvent 46 and the water have been present are to be left as fine clearances Sx (see FIG. 53).

In the adsorption material 4, the fine clearances Sx formed in the adsorption material 4 are communicated with each other to become capillary clearances Sx (see FIG. 5B). Thereby, the coolant (CG_in : refer to FIG. 1) such as the ethanol supplied into the tubular case 2 of the adsorption device 1 can enter the inside of the adsorption material 4 through the clearance Sx of the adsorption material 4.

Therefore the coolant can be adsorbed to the entire adsorption material 4 by the clearances Sx formed in the inside of the adsorption material 4, and the time required for the adsorption can be shortened. Accordingly the adsorption efficiency of the coolant to the adsorption material 4 improves.

When the treatment in the evaporating step is completed, the main body part 31 and the form 7 are together heated in a second temperature range (for example, 120° C. to 150° C.) for a predetermined time (step 04 in FIG. 2: hardening step). Thereby, the binder resin 42 contained in the filler 45 is once softened and then hardened (step 104 in FIG. 2: hardening step).

It is preferable that the second temperature range in this step 104 is a temperature range for being capable of softening the binder resin 42.

In the embodiment, since the adsorption material 4 is prepared using the binder resin 42 a softening temperature of which is higher than the aforementioned first temperature range, the second temperature range is a temperature range higher than the aforementioned first temperature range. Therefore, the second temperature range may be changed in accordance with the adopted binder resin 42.

As a result, the binder resin 42 hardened after being softened connects the adsorption material 4 with each other to hold the shape of a lump of the adsorption material 4 and connect the adsorption material 4 and the heat-transfer member 34. Therefore it is possible to continue to hold the lump of the adsorption material 4 in the area α for accommodation of the heat-transfer members 34.

Here, in the embodiment, since the cationic binder resin 42 is used, it is preferable to execute an anti-rust treatment on a surface of the heat-transfer member 34 using an anionic treatment agent.

In this case, since the cationic binder resin 42 and the anionic treatment agent are strongly bound, it is possible to continue to more securely hold the lump of the adsorption material 4 in the area α for accommodation of the heat-transfer members 34.

As described above, according to the embodiment,
(1) A method for preparing the adsorption device 1, in which a plurality of heat-transfer members 34 are arranged with interval with each other and activated carbons (porous particles 41: adsorption materials) are held in an area a in the main body part 31 for accommodating the plurality of heat-transfer members 34 is disclosed.

The method includes a steps of:

the filling step (step 102) for filling the slurry filler 45, in which the porous particles 41 and the binder resins 42 are dispersed in the solvent 46, into the area α, and thereby at least the clearances S and Sa are filled with the filler 45, the clearances S (see FIG. 3B) is between the heat-transfer member 34 and the heat-transfer member 34, and the clearances Sa (see FIG. 3B) is between the heat-transfer member 34 and the peripheral wall 71;

the evaporating step (step 103) for evaporating the solvent 46 by heating the main body part 31 in which the filler 45 is filled in the area a at the first temperature range (for example, 80° C. to 100° C.) suitable for evaporating the solvent 46; and

the hardening step (step 104) for hardening the binder resin 42 by heating the main body part 31 from which the solvent 46 is evaporated in the evaporating step (step 103) with the second temperature range (for example, 120° C. to 150° C.), the second temperature range is higher in temperature than the first temperature range and is adequate for hardening the binder resin 42.

With this configuration, the distribution of the binder resins 42 becomes uniform in the filler 45 after removing the solvent 46. Thereby, when the binder resins 42 are hardened in the hardening step (step 104), it is possible to hold the shape of the entire adsorption material 4 by the hardened binder resins 42. Therefore it is possible to continue to hold the filler 45 filled between the heat-transfer member 34 and the heat-transfer member 34 in the predetermined position without falling down from the adsorption device 1.

In addition, when the solvent 46 is evaporated in the evaporating step (step 103), the area where the solvent 46 has been positioned is left as the fine clearance Sx. This clearance acts as the flowing passage of the coolant (ethanol) that the adsorption material 4 adsorbs/desorbs to improve an adsorption speed of the coolant to the adsorption material 4.
(2) In the filling step (step 102), the filling of the filler 45 into at least the clearance S and the clearance Sa is performed while vibrating the main body part 31, the clearance S is between the heat-transfer member 34 and the heat-transfer member 34, and the clearance Sa is between the heat-transfer member 34 and the peripheral wall 71.

With this configuration, the air bubbles in the inside of the slurry filler 45, filled between the heat-transfer member 34 and the heat.-transfer member 34, can be removed by the vibration transmitted to the filler 45 through the main body part 31. Thereby, the filler 45 can be filled in the area a without any clearance.

Particularly the corrugate fin 35 is provided between the heat-transfer member 34 and the heat-transfer member 34. It is difficult to densely fill the slurry filler 45 in the narrow clearances surrounded by the corrugate fin 35 in the space between the heat-transfer member 34 and the heat-transfer member 34. But the filler 45 can be filled with no clearance without taking air inside by filling the slurry filler 45 while giving the vibration thereto.

When a large space due to the air bubble exists in the inside of the adsorption material 4 after hardening the binder resins 42, (A) since this large space is not involved in the adsorption/desorption of the coolant, the adsorption efficiency of the coolant is lowered. In addition, (B) when a large space due to the air bubble exists in the inside of the adsorption material 4 after hardening the binder resin 42, the adsorption material 4 is more likely to collapse on a basis of the space at the time the vibration or the like acts on the adsorption material 4 in a predetermined shape held between the heat-transfer member 34 and the heat-transfer member 34. Further, (C) when the adsorption material 4 after hardening the binder resins 42 collapses without being capable of holding the predetermined shape, a total amount of the adsorption material 4 that can be adsorbed/desorbed by the adsorption device 1 is made small.

As described above, the air bubble in the inside of the slurry filler 45 is removed by filling the slurry filler 45 while giving the vibration thereto, and thereafter the evaporation of the solvent 46 in the inside of the filler 4 5 (step 103: evaporating step) and the hardening of the binder resin 42 (step 104: hardening step) are performed. This process can prevent the occurrence of the event that the adsorption material 4 after hardening the binder resins 42 collapses without being capable of holding the predetermined shape. As a result, since the total amount of the adsorption material 4 that can be adsorbed/desorbed by the adsorption device 1 is not made small, the adsorption/desorption of adsorbed medium to the adsorption material 4 can be appropriately performed.
(3) The slurry filler 45 is prepared via following steps: the first mixing step for mixing the porous particles 41 and the solvent 46 while adding the solvent 46 to the porous particles 41; and

the second mixing step for mixing the porous particles 41, the solvent 46 and the binder resins 42 by adding the binder resins 42 to the mixture, which is obtained by mixing the porous particles 41 and the solvent 46 at first mixing step.

With this configuration, after the porous particles 41 are saturated with the solvent 46, the binder resins 42 are mixed with the mixture of the porous particles 41 and the solvent 46. Thereby, the amount of the binder resins 42 to be adsorbed to the porous particles 41 can be suppressed.

Therefore the amount, of the porous particles 41 involved in the adsorption/description of the adsorbed medium can prevented from being made small. Further, when the binder resin 42 is adsorbed in the porous particle 41, the amount of the binder resins 42 involved in holding the shape of the adsorption material 4 after hardening the binder resins 42 is made small.

In this case, creating a possibility of being incapable of keeping the shape of the adsorption material 4 between the heat-transfer member 34 and the heat-transfer member 34 at a predetermined shape. However, occurrence of the above event can be appropriately prevented.
(4) The cooling step for cooling the mixture formed by mixing the porous particles 41 and the solvent 46 is provided between the first mixing step and the second mixing step.

With this configuration, the second mixing step can be executed, after cooling the mixture, which is obtained by mixing the porous particles 41 with the solvent 46 at the first mixing step, to a temperature lower than a hardening temperature of the binder resin 42 that will be mixed in the second mixing step.

When the solvent 46 (for example, ethanol/water) is added to the porous particles 41 (for example, activated carbons), heat is generated due to adsorption of the solvent 46 to the porous particles 41. When the mixture, which is obtained by mixing the porous particles 41 and the solvent 46, is cooled after reaching the second temperature range, which corresponds to the hardening temperature of the binder resin 42 to be mixed in the second mixing step, the binder resin 42 is hardened on the way of mixing the porous particle 41, the solvent 46 and the binder resin 42. In this case, expecting occurrence of the event that the porous particles 41 and the binder resins 42 may not equally distributed in the adjusted filler 45.

Therefore, the second mixing step is executed after reducing the crude neat due to the adsorption by cooling the mixture, which is obtained by mixing the porous particles 41 with the solvent 46 at the first mixing step. Thereby it is possible to mix the mixture of the porous particles 41 and the solvent 46 with the binder resins 42 in the temperature lower than the hardening temperature of the binder resin 42 to be mixed in the second mixing step.

Accordingly it is possible to appropriately prevent the occurrence of the event, that the binder resins 42 are hardened on the way of the mixing and the porous particles 41 and the binder resins 42 are not equally distributed in the prepared filler 45.
(5) The solvent 46 contains the coolant (adsorbed medium) that is to be adsorbed to the porous particle 41 (adsorption material). The adsorption device 1 prepared via the evaporating step (step 103) and the hardening step (step 104) has the clearances Sx into which the entry of the coolant is possible between the porous particles 41 (adsorption materials).

With this configuration, since the area where the solvent 46 has been positioned is left as the fine clearance Sx, this clearance Sx acts as the flow passage of the coolant (ethanol) adsorbed/desorbed by the adsorption material 4. Thus improving the adsorption speed of the coolant to the adsorption material 4.
(6) The porous particle 41 is the activated carbon, the solvent 46 is the ethanol, the binder resin 42 is the water-soluble binder resin having a cationic property, and the coolant is the ethanol. In the second mixing step, the binder resin 42 is mixed with the mixture of the activated carbon and the ethanol as the water solution in which the binder resins is dispersed in the water.

With this configuration, since the activated carbon has the weak anionic property, when the cationic resin is used as the binder resin, the activated carbon having the weak anionic property and the cationic resin are pulled to each other. As a result, the activated carbon and the binder are more strongly bound.

Accordingly the shape of the entire adsorption material 4 filled between the heat-transfer member 4 and the heat-transfer member 34 can be held, which makes it possible to continue to hold the adsorption material 4 in the predetermined position without falling down from the adsorption device 1.

In addition, since the activated carbon has non-polarity and is high in an affinity for the ethanol with the polarity and the water, it is possible to adjust the filler 45 in which the activated carbons and the binder resins 42 are equally distributed.

Further, in the evaporating step (step 103), when the ethanol and the water contained in the filler 45 are evaporated, the area where the ethanol and the water have existed in the filler 45 is left as the capillary clearance Sx in the adsorption material 4 which is finally acquired.

Then, since the coolant can enter the inside of the adsorption material 4 passing through the clearance Sx at the time of causing the adsorption material 4 to adsorb/desorb the coolant, the adsorption efficiency of the coolant to the adsorption material 4 improves.

In addition, since the coolant and the solvent are composed of the same ethanol, the clearance Sx formed in the adsorption material 4 is formed in a size suitable for the entry of the ethanol into the inside and the transfer of the ethanol.

For example, in a case where the solvent is composed of water only, since a size of a water molecule is smaller than an ethanol molecule, a size of the clearance Sx formed in the adsorption material 4 is suitable for the entry of the water molecule, but is not suitable for the entry of the ethanol molecule.

On the other hand, when the solvent is composed of the same ethanol as the coolant, a size of the clearance formed in the adsorption material 4 can be made to be suitable for the entry of the ethanol molecule. Accordingly since the coolant can enter the inside of the adsorption material 4 passing through the clearance Sx at the time of causing the adsorption material 4 to adsorb/desorb the coolant, an improvement on the adsorption efficiency of the coolant to the adsorption material 4 is expected.

It should be noted that the solvent 46 is not limited to the ethanol, but other alcohol solvents, water, a mixture of ethanol and water and the like that can be evaporated in less than 100° C. may be adopted.
(7) A weight ratio of the cationic resins to the activated carbons is defined to be in a range of 1:0.05 to 1:0.15.

With this configuration, it is possible to continue to hold the shape of the adsorption material 4 after hardening the binder resin 42 in a predetermined shape.
(8) A weight ratio of the ethanol to the activated carbons is defined to be in a range of 1:3 to 1:5.

With this configuration, it is possible to prepare the slurry filler 45 having fluidity suitable for the filling between the heat-transfer member 34 and the heat-transfer member 34.

In addition, since the viscosity of the finally prepared slurry filler 45 does not become excessively low, the activated carbon and the ethanol cannot be separated for a short time in the prepared filler 45.
(9) An upper limit of the particle diameter of the activated carbon is equal to or less than 120 μm, and a lower limit thereof is a minimum particle diameter for enabling securing a clearance between the activated carbon and the other activated carbon neighbored thereto, preferably the clearance Sx through which the adsorbed medium to be adsorbed to the activated carbon can flow.

With this configuration, it is possible to hold the activated carbons of the amount required for the adsorption of the coolant at least between the heat-transfer member 34 and the heat-transfer member 34 among the area a for accommodating the heat-transfer members 34, the adsorption/desorption of the coolant can be appropriately performed.

In addition, when the activated carbons are densely arranged without any clearance between the activated carbon and the other activated carbon neighbored thereto in the inside of the adsorption material 4, the coolant cannot enter the inside of the adsorption material 4.

But when the diameter of the activated carbon is made to be the minimum particle diameter for being capable of securing the clearance between the activated carbon and the other activated carbon neighbored thereto, since the coolant enters the clearance to be adsorbed in the activated carbon, it is possible to secure the adsorption amount of the coolant in the entire adsorption material 4.

It should be noted that in the aforementioned embodiment, an explanation is made by taking a case of using the ethanol as the solvent 46, as an example, but even when pure water (industry water) not containing impure substances such as chlorine is used as the solvent, a functional effect similar to a case of the ethanol can be acquired.

In addition, in the aforementioned evaporating step (step 103), there is shown as an example a case where a temperature in an unillustrated heating furnace is set to the first temperature range (for example, 80° C. to 100° C.) suitable for evaporating the solvent 46 and the water contained in the binder resin 42. But the temperature is not limited thereto. For example, the temperature maybe a temperature (for example, 50° C. to 70° C.) under which it takes time for the solvent 46 and the water contained in the binder resin 42 to evaporate.

In addition, in the aforementioned embodiment, there is shown as an example a case where the water solution of the binder resin 42, in which the cationic water-soluble resins are dispersed in the water and/or in the ethanol, is mixed with the mixture of the activated carbon and the ethanol. But the water solution is not limited thereto. For example, a water solution of a binder resin in which the cationic water-soluble resins are dispersed in water may be mixed in the mixture of the activated carbon and the ethanol.

In addition, a solution of a binder resin in which the cationic water-soluble resins are dispersed in ethanol may be mixed in the mixture of the activated carbon and the ethanol.

In this case, the first temperature range in the evaporating step (step 103) can be set to a lower temperature range.

### DESCRIPTION OF REFERENCE SIGNS

1 Adsorption device
2 Tubular case
3 Adsorption material module
31 Main body part
32 Branching tank
33 Merging tank
34 Heat-transfer member
35 Corrugate fin
4 Adsorption material
41 Porous particle (activated carbon)
42 Binder resin
45 Filler
46 Solvent
7 Form
71 Bottom wall
72 Peripheral wall
W Heat exchange medium
CG Adsorbed medium

1-11. (canceled)

12. A method for preparing an adsorption device, in which a plurality of heat-transfer members are arranged with interval with each other and adsorption materials are held in an area in a main body part for accommodating the plurality of heat-transfer members,
the method includes a steps of:
a filling step for filling a slurry filler, in which the adsorption materials and binders are dispersed in a solvent, in the area;
an evaporating step for evaporating the solvent by heating the main body part in which the filler is filled in the area with a first temperature range adequate for the evaporation of the solvent; and
a hardening step for hardening the binders by heating the main body part, from which the solvent is evaporated in the evaporating step, with a second temperature range, the second temperature range is higher in temperature than the first temperature range and is adequate for the harden the binders

13. The method for preparing the adsorption device according to claim 12, wherein
in the filling step, the filler is filled in the area while vibrating the main body part.

14. The method for preparing the adsorption device according to claim 12, wherein
the slurry filler is prepared via following steps:
a first mixing step for mixing the adsorption material and the solvent while adding the solvent to the adsorption material; and
a second mixing step for mixing the adsorption material, the solvent and the binder by adding the binder to a mixture of the adsorption material and the solvent.

15. The method for preparing the adsorption device according to claim 14, further including:
a cooling step for cooling the mixture of the adsorption material and the solvent, the cooling step is provided between the first mixing step and the second mixing step.

16. The method for preparing the adsorption device according to claim 13, wherein
the slurry filler is prepared via following steps:
a first mixing step for mixing the adsorption material and the solvent while adding the solvent to the adsorption material; and
a second mixing step for mixing the adsorption material, the solvent and the binder by adding the binder to a mixture of the adsorption material and the solvent.

17. The method for preparing the adsorption device according to claim 16, further including:
a cooling step for cooling the mixture of the adsorption material and the solvent, the cooling step is provided between the first mixing step and the second mixing step.

18. The method for preparing the adsorption device according to claim 12, wherein
the solvent contains an adsorbed medium that is to be adsorbed to the adsorption material, and
in the adsorption device prepared via the evaporating step and the hardening step, a clearance enabling entry of the adsorbed medium is formed between the adsorption materials.

19. The method for preparing the adsorption device according to claim 18, wherein
the adsorption material includes an activated carbon, the solvent includes ethanol, the binder includes a cationic resin, and the adsorbed medium includes ethanol.

20. The method for preparing the adsorption device according to claim 19, wherein
a weight ratio of the cationic resin to the activated carbon is in a range of 1:0.05 to 1:0.15.

21. The method for preparing the adsorption device according to claim 19, wherein
a weight ratio of the ethanol to the activated carbon is in a range of 1:3 to 1:5.

22. The method for preparing the adsorption device according to claim 20, wherein
a weight ratio of the ethanol to the activated carbon is in a range of 1:3 to 1:5.

23. The method for preparing the adsorption device according to claim 19, wherein
an upper limit of a particle diameter of the activated carbon is 120 μm.

24. The method for preparing the adsorption device according to claim 23, wherein
a lower limit of the particle diameter of the activated carbon is a minimum particle diameter enabling the activated carbon to secure a clearance between the activated carbon and another activated carbon neighbored thereto.

25. The method for preparing the adsorption device according to claim 12, wherein
the adsorption material includes an activated carbon, the solvent includes ethanol, water or a mixture of ethanol and water and the binder includes a cationic resin.

26. The method for preparing the adsorption device according to claim 25, wherein
an upper limit of a particle diameter of the activated carbon is 120 μm.

27. The method for preparing the adsorption device according to claim 26, wherein
a lower limit of the particle diameter of the activated carbon is a minimum particle diameter enabling the activated carbon to secure a clearance between the activated carbon and another activated carbon neighbored thereto.
